(19) United States
(12) Patent Application Publication
(10) Pub. No.: US 2024/0310865 A1
(43) Pub. Date: Sep. 19, 2024

(54) Elevator Button Bezel Assembly

(71) Applicant: Adam Clayton, Elmhurst, IL (US)

(72) Inventor: Adam Clayton, Elmhurst, IL (US)

(21) Appl. No.: 18/122,331

(22) Filed: Mar. 16, 2023

(51) Int. Cl. G05G 5/00; B66B 1/46

(52) U.S. Cl. CPC G05G 5/005; B66B 1/46; G05G 2505/00

(57) ABSTRACT

An elevator button bezel assembly includes an emergency call button that is integrated into a control panel of an elevator. In this way the emergency call button can be engaged by a user in the event of an emergency. A bezel is provided and the bezel is positioned around the emergency call button. The bezel has a depth that is greater than a thickness of the emergency call button such that the bezel extends outwardly beyond the emergency call button. In this way the bezel inhibits the user from inadvertently engaging the emergency call button by bumping against the emergency call button.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to bezel device and more particularly pertains to a new bezel device for inhibiting an emergency call button in an elevator from being inadvertently engaged. The device includes a bezel that is installed around the emergency call button in the elevator. The bezel has a depth that is sufficient to facilitate the bezel to extend outwardly beyond an exposed surface of the emergency call button. In this way the bezel inhibits the emergency call button from being inadvertently engaged.

### (2) Description of Related Art Including Information Disclosed Under 37 CFR 1.97 and 1.98

The prior art relates to bezel devices including a lockout device for a push button which is pivotally positioned on the push button. The prior art discloses an alarm activation device that includes a compressible dome that is positioned over an alarm button. The prior art discloses a push button device that includes a push button and a bezel surrounding the push button.

### BRIEF SUMMARY OF THE INVENTION

An embodiment of the disclosure meets the needs presented above by generally comprising an emergency call button that is integrated into a control panel of an elevator. In this way the emergency call button can be engaged by a user in the event of an emergency. A bezel is provided and the bezel is positioned around the emergency call button. The bezel has a depth that is greater than a thickness of the emergency call button such that the bezel extends outwardly beyond the emergency call button. In this way the bezel inhibits the user from inadvertently engaging the emergency call button by bumping against the emergency call button.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of bezel of an embodiment of the disclosure.

FIG. 2 is a front view of a bezel of an embodiment of the disclosure.

FIG. 3 is a left side phantom view of a bezel of an embodiment of the disclosure.

FIG. 4 is a back view of a bezel of an embodiment of the disclosure.

FIG. 5 is an exploded perspective view of a bezel of an embodiment of the disclosure.

FIG. 6 is a front in-use view of an elevator button bezel assembly according to an embodiment of the disclosure.

FIG. 7 is an exploded perspective view of an emergency call button and a bezel of an embodiment of the disclosure.

### DETAILED DESCRIPTION OF THE INVENTION

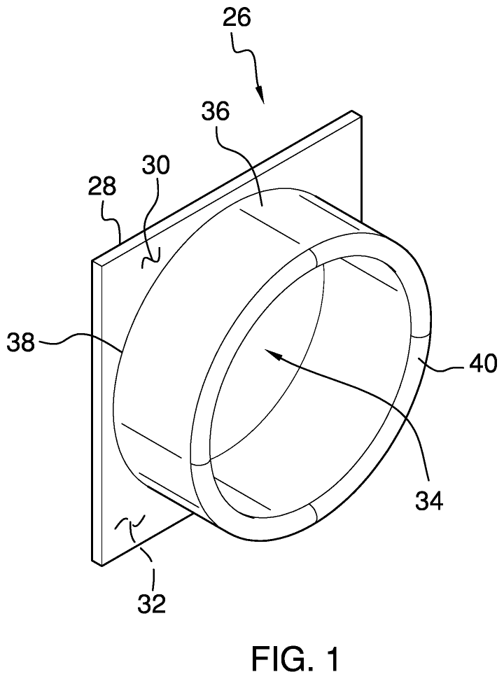

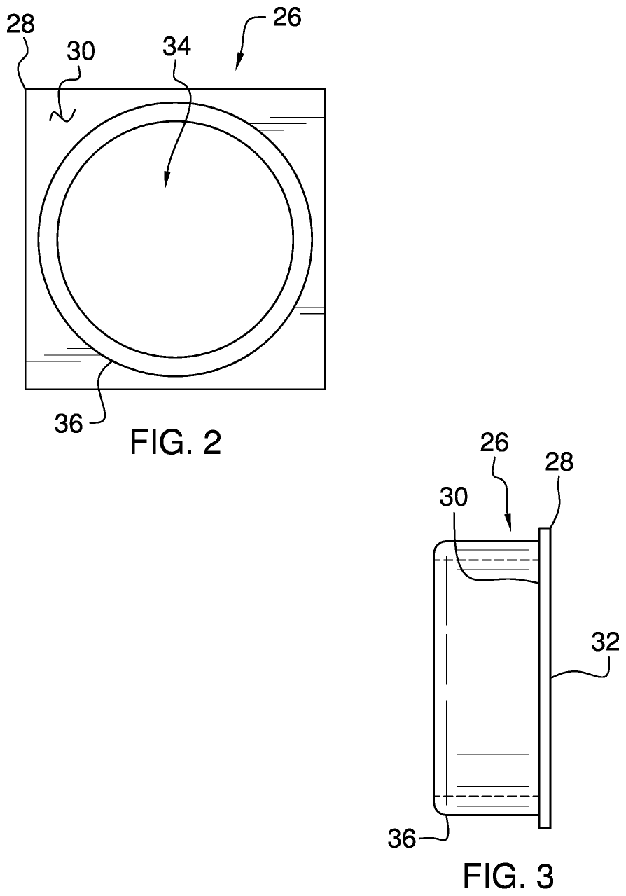

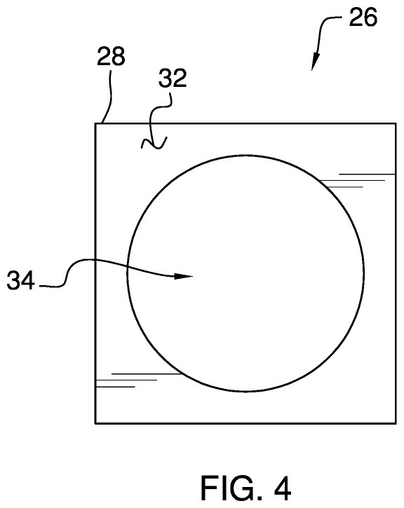

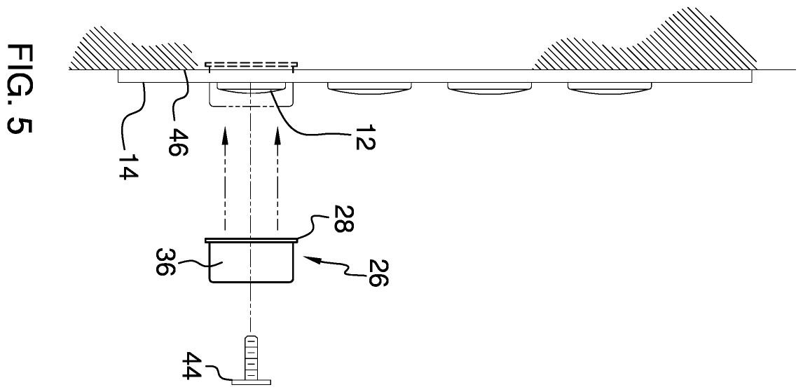

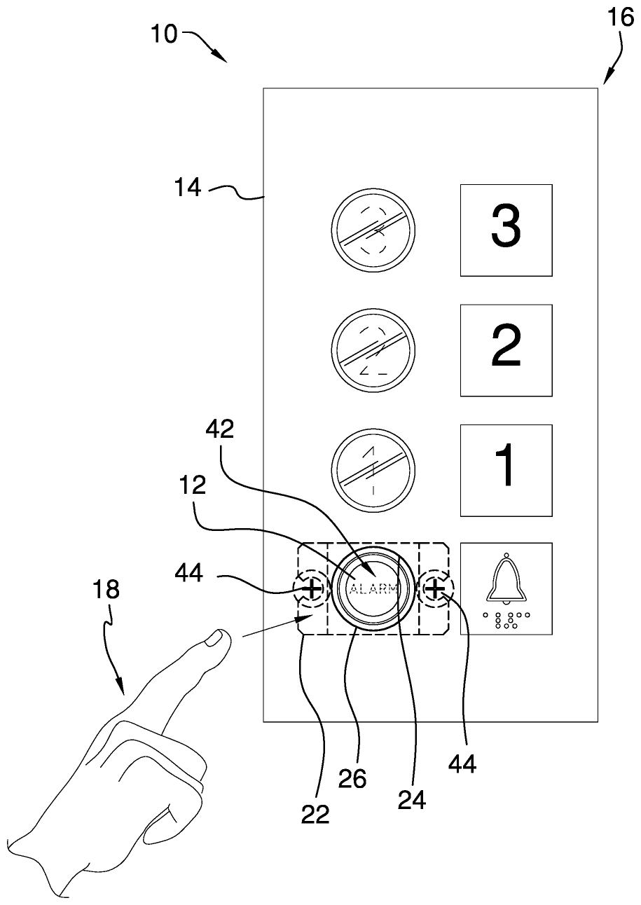

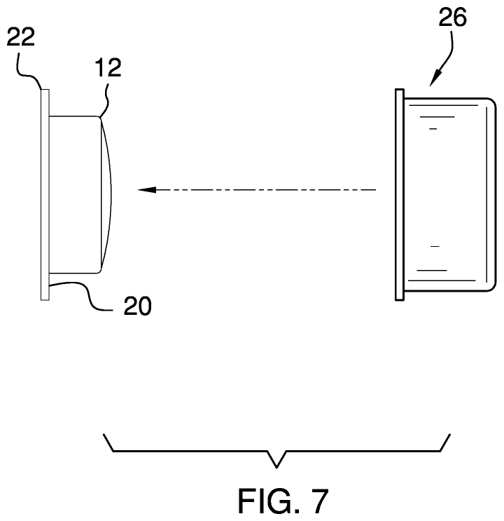

With reference now to the drawings, and in particular to FIGS. 1 through 7 thereof, a new bezel device embodying the principles and concepts of an embodiment of the disclosure and generally designated by the reference numeral 10 will be described.

As best illustrated in FIGS. 1 through 7, the elevator button bezel assembly 10 generally comprises an emergency call button 12 that is integrated into a control panel 14 of an elevator 16. In this way the emergency call button 12 can be engaged by a user 18 in the event of an emergency. The emergency call button 12 is integrated into a forward surface 20 of a mounting panel 22 and the mounting panel 22 is positioned behind the control panel 14 such that the emergency call button 12 extends outwardly through an opening 24 in the control panel 14. The elevator 16 may be a commercial elevator of any conventional design that is commonly found in multi-story public buildings or the like.

A bezel 26 is provided which is positioned around the emergency call button 12. The bezel 26 has a depth that is greater than a thickness of the emergency call button 12 such that the bezel 26 extends outwardly beyond the emergency call button 12. In this way the bezel 26 inhibits the user 18 from inadvertently engaging the emergency call button 12 by bumping against the emergency call button 12. Thus, the bezel 26 reduces the occurrence of false calls to emergency responders that can occur with emergency call buttons in elevators that are inadvertently engaged.

The bezel 26 comprises a bezel panel 28 that has a front surface 30 and a back surface 32; the bezel panel 28 has an opening 34 extending through the front surface 30 and the back surface 32 and the opening 34 is centrally positioned on the bezel panel 28. The back surface 32 of the bezel panel 28 is positioned against the forward surface 20 of the mounting panel 22 associated with the emergency call button 12 such that the bezel panel 28 is positioned between the mounting panel 22 and a back side of the control panel 14. Furthermore, the emergency call button 12 extends through the opening 34 in the bezel panel 28.

The bezel 26 includes an annular ring 36 which has a rear edge 38 and a forward edge 40. The rear edge 38 is bonded to the front surface 30 of the bezel panel 28 having the annular ring 36 surrounding the opening 34 in the bezel panel 28 such that the annular ring 36 surrounds the emergency call button 12. A distance between the rear edge 38 and the forward edge 40 is greater than a thickness of the emergency call button 12 such that the forward edge 40 is spaced outwardly beyond an exposed surface 42 of the emergency call button 12. The distance between the rear edge 38 and the forward edge 40 is sufficient to facilitate the forward edge 40 to be spaced at least 6.0 mm beyond the exposed surface 42 of the emergency call button 12. As is most clearly shown in FIG. 6, a pair of fasteners 44 may extend through the mounting panel 22 for attaching the mounting panel 22 and the emergency call button 12 to a support surface 46 upon which the control panel 14 is mounted.

In use, the control panel 14 is removed from the elevator 16, the existing bezel 26 on the emergency call button 12 is removed and the bezel 26 described in the preceding disclosure is positioned on the mounting panel 22 associated with the emergency call button 12 such that the annular ring 36 surrounds the emergency call button 12. The control panel 14 is replaced such that the bezel 26 is positioned between the mounting panel 22 and the control panel 14 thereby securing the bezel 26 in place. In this way the annular ring 36 extends outwardly beyond the exposed surface 42 of the emergency call button 12 to inhibit the user 18 from inadvertently engaging the emergency call button 12. The bezel 26 described in the preceding disclosure can be installed during the manufacturing process of the elevator 16 such that the bezel 26 described in the preceding disclosure is a factory installed component of the elevator 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An elevator button bezel assembly for inhibiting an emergency call button in an elevator from being inadvertently engaged, said assembly comprising:
an emergency call button being integrated into a control panel of an elevator wherein said emergency call button is configured to be engaged by a user in the event of an emergency; and
a bezel being positioned around said emergency call button, said bezel having a depth being greater than a thickness of said emergency call button such that said bezel extends outwardly beyond said emergency call button wherein said bezel is configured to inhibit the user from inadvertently engaging said emergency call button by bumping against said emergency call button.

2. The assembly according to claim 1, wherein:
said emergency call button is integrated into a forward surface of a mounting panel, said mounting panel being positioned behind said control panel such that said emergency call button extends outwardly through an opening in said control panel;
said bezel comprises a bezel panel having a front surface and a back surface, said bezel panel having an opening extending through said front surface and said back surface, said opening being centrally positioned on said bezel panel, said back surface of said bezel panel being positioned against a forward side of said mounting panel associated with said emergency call button such that said bezel panel is positioned between said mounting panel and a back side of said control panel; and
said emergency call button extends through said opening in said bezel panel.

3. The assembly according to claim 2, wherein said bezel includes an annular ring having a rear edge and a forward edge, said rear edge being bonded to said front surface of said bezel panel having said annular ring surrounding said opening in said bezel panel such that said annular ring surrounds said emergency call button.

4. The assembly according to claim 1, wherein:
said emergency call button is integrated into a forward surface of a mounting panel; and
said bezel comprises:
a bezel panel having a front surface and a back surface, said bezel panel having an opening extending through said front surface and said back surface, said opening being centrally positioned on said bezel panel, said emergency call button extending through said opening; and
an annular ring having a rear edge and a forward edge, said rear edge being bonded to said front surface of said bezel panel having said annular ring surrounding said opening in said bezel panel such that said annular ring surrounds said emergency call button, a distance between said rear edge and said forward edge being greater than a thickness of said emergency call button such that said forward edge is spaced outwardly beyond an exposed surface of said emergency call button.

5. An elevator button bezel assembly for inhibiting an emergency call button in an elevator from being inadvertently engaged, said assembly comprising:
an emergency call button being integrated into a control panel of an elevator wherein said emergency call button is configured to be engaged by a user in the event of an emergency, said emergency call button being integrated into a forward surface of a mounting panel, said mounting panel being positioned behind said control panel such that said emergency call button extends outwardly through an opening in said control panel; and
a bezel being positioned around said emergency call button, said bezel having a depth being greater than a thickness of said emergency call button such that said bezel extends outwardly beyond said emergency call button wherein said bezel is configured to inhibit the user from inadvertently engaging said emergency call button by bumping against said emergency call button, said bezel comprising:
a bezel panel having a front surface and a back surface, said bezel panel having an opening extending through said front surface and said back surface, said opening being centrally positioned on said bezel panel, said back surface of said bezel panel being positioned against said forward surface of said mounting panel associated with said emergency call button such that said bezel panel is positioned between said mounting panel and a back side of said control panel, said emergency call button extending through said opening in said bezel panel; and
an annular ring having a rear edge and a forward edge, said rear edge being bonded to said front surface of said bezel panel having said annular ring surrounding said opening in said bezel panel such that said annular ring surrounds said emergency call button, a distance between said rear edge and said forward edge being greater than a thickness of said emergency call button such that said forward edge is spaced outwardly beyond an exposed surface of said emergency call button.

6. A method of inhibiting an emergency call button in an elevator from being inadvertently engaged, the steps of said method comprising:
providing an elevator having a control panel and an emergency call button extending through said control panel;
providing a bezel comprising a bezel panel and an annular ring extending away from said bezel panel, said annular ring having a depth being greater than a thickness of said emergency call button; and
installing said bezel panel behind a control panel in said elevator such that annular ring surrounds said emergency call button having said annular ring extending outwardly beyond an exposed surface of said emergency call button thereby inhibiting said emergency call button from being inadvertently engaged.
